(19) United States
(12) Patent Application Publication
(10) Pub. No.: US 2025/0086688 A1
(43) Pub. Date: Mar. 13, 2025

(54) SUPPLY CHAIN PREDICTIONS USING METAVERSE BEHAVIORS

(71) Applicant: INTERNATIONAL BUSINESS MACHINES CORPORATION, Armonk, NY (US)

(72) Inventors: Shahrokh Daijavad, Morgan Hill, CA (US); Dinesh C. Verma, New Castle, NY (US); David Joel Edelsohn, White Plains, NY (US); Dan Gutfreund, Brighton, MA (US)

(21) Appl. No.: 18/465,290

(22) Filed: Sep. 12, 2023

(51) Int. Cl. G06Q 30/0601; G06Q 10/087; G06Q 30/0282

(52) U.S. Cl. CPC G06Q 30/0631; G06Q 10/087; G06Q 30/0282; G06Q 30/0623; G06Q 30/0641

(57) ABSTRACT

A method, computer system, and a computer program product for supply chain optimization is provided. The present invention may include receiving augmented reality data from a plurality of users. The present invention may include categorizing the augmented reality data into one or more cohort groups according to attributes of the plurality of users. The present invention may include utilizing the one or more cohort groups to define a plurality of new products. The present invention may include presenting one or more of the plurality of new products to a user based on at least one of the one or more cohort groups to which the user belongs.

### BACKGROUND

The present invention relates generally to the field of computing, and more particularly to supply chain networks and metaverse data optimization.

Brick and mortar retail stores and their associated eCommerce platforms may utilize the data gathered from their consumers such that they may offer more desirable products and/or predict supply chain needs based on consumer transactions. However, increasingly the associated eCommerce platforms may offer Augmented Reality (AR) and/or Virtual Reality (VR) experiences to their consumers within their eCommerce applications. The consumers may provide additional data within these eCommerce applications and/or interact with products in a manner distinct from traditional interactions and may provide a new and untapped set of data that may be utilized in further predicting supply chain needs and consumer preferences for new or updated products.

### SUMMARY

Embodiments of the present invention disclose a method, computer system, and a computer program product for supply chain optimization. The present invention may include receiving augmented reality data from a plurality of users. The present invention may include categorizing the augmented reality data into one or more cohort groups according to attributes of the plurality of users. The present invention may include utilizing the one or more cohort groups to define a plurality of new products. The present invention may include presenting one or more of the plurality of new products to a user based on at least one of the one or more cohort groups to which the user belongs.

In another embodiment, the method may include utilizing a machine learning model to compare cohort group attributes with user attributes in determining at least one of the one or more cohort groups to which the user belongs.

In a further embodiment, the method may include transmitting supply chain data for at least one of the one or more products presented to the user to a manufacturer following a completion of an order transaction by the user.

In yet another embodiment, the method may include receiving feedback from the user on the at least one product following the completion of the order transaction, performing a sentiment analysis on the feedback received from the user, and updating data stored in a knowledge corpus, wherein the updated data is utilized in retraining one or more AI based algorithms to refine at least one of the plurality of new products.

In addition to a method, additional embodiments are directed to a computer system and a computer program product for deriving new and untapped data from user interactions within a metaverse environment associated with an eCommerce platform which may be utilized in providing richer training for Artificial Intelligence (AI) based algorithms which may provide additional supply chain and/or customer preference insights.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for supply chain optimization according to at least one embodiment.

### DETAILED DESCRIPTION

The following described exemplary embodiments provide a system, method and program product for supply chain optimization. As such, the present embodiment has the capacity to improve the technical field of supply chain networks and metaverse data optimization by deriving new and untapped data from user interactions within a metaverse environment associated with an eCommerce platform which may be utilized in providing richer training for Artificial Intelligence (AI) based algorithms which may provide additional supply chain and/or customer preference insights. More specifically, the present invention may include receiving augmented reality data from a plurality of users. The present invention may include categorizing the augmented reality data into one or more cohort groups according to attributes of the plurality of users. The present invention may include utilizing the one or more cohort groups to define a plurality of new products. The present invention may include presenting one or more of the plurality of new products to a user based on at least one of the one or more cohort groups to which the user belongs.

As described previously, brick and mortar retail stores and their associated eCommerce platforms may utilize the data gathered from their consumers such that they may offer more desirable products and/or predict supply chain needs based on consumer transactions. However, increasingly the associated eCommerce platforms may offer Augmented Reality (AR) and/or Virtual Reality (VR) experiences to their consumers within their eCommerce applications. The consumers may provide additional data within these eCommerce applications and/or interact with products in a manner distinct from traditional interactions and may provide a new and untapped set of data that may be utilized in further predicting supply chain needs and consumer preferences for new or updated products.

Therefore, it may be advantageous to, among other things, receive augmented user-generated data from a plurality of users, categorize the augmented user-generated data into one or more cohort groups according to attributes of the plurality of users, utilize the one or more cohort groups to define a plurality of new products, and present one or more of the plurality of new products to a user based on at least one of the one or more cohort groups to which the user belongs.

According to at least one embodiment, the present invention may improve supply chain networks by utilizing new augmented user-generated data in addition to traditionally utilized non-metaverse data as additional input for one or more AI-based algorithms which may enable more accurate prediction of supply chain needs and customer preferences for identified cohort groups.

According to at least one embodiment, the present invention may improve user interaction interfaces for eCommerce platforms by enabling the user to interact with one or more of a plurality of new products defined according to the augmented user-generated data within a supply chain optimization user interface and utilizing the existing infrastructure of the eCommerce platform to complete the transaction.

According to at least one embodiment, the present invention may improve the supply chain network for an eCommerce platform by transmitting supply chain data for at least one of the one or more products presented to the user to a manufacturer following a completion of an order transaction by the user which may enable the eCommerce platform to centralize the production and/or manufacturing of particular parts and/or components of the new products in geographic regions proximate to an associated cohort group which may reduce production costs, shipping costs, and/or other expenses.

According to at least one embodiment, the present invention may improve product offerings and/or groups of product offerings by leveraging augmented user-generated data to produce products that fit the needs of specific cohort groups identified which may also reduce waste and increase customer satisfaction.

According to at least one embodiment, the present invention may improve supply chain requirement predictions collecting of permanent data that is generated during a transient virtual reality-based interaction of end users with eCommerce platforms by receiving augmented user-generated data and categorizing the anonymized augmented user-generate data into cohort groups using attributes of a plurality of users wherein the categorizing uses the same analytics that may be used on non-virtual reality-based augmented user generated data. The invention may then further leverage the categorizing to define new groups of products and feed the categorized augmented user-generated data into one or more AI-based algorithms for richer training and more accurate prediction of supply chain requirements for the new groups of products.

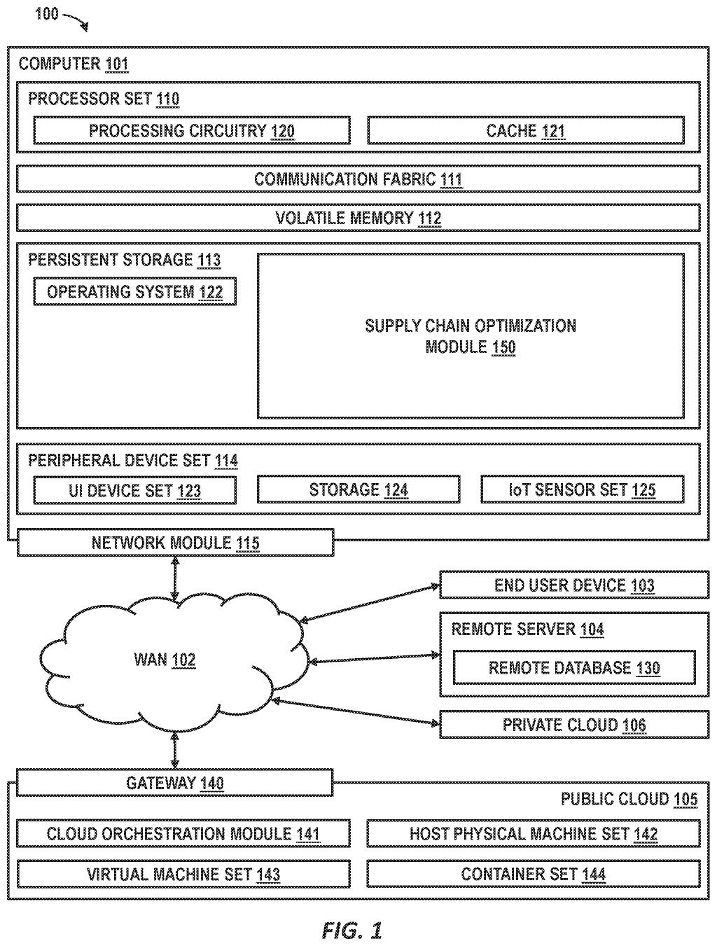

Referring to FIG. 1, Computing environment 100 contains an example of an environment for the execution of at least some of the computer code involved in performing the inventive methods, such as for deriving new and untapped data from user interactions within a metaverse environment associated with an eCommerce platform which may be utilized in providing richer training for Artificial Intelligence (AI) based algorithms which may provide additional supply chain and/or customer preference insights using a supply chain optimization module 150. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

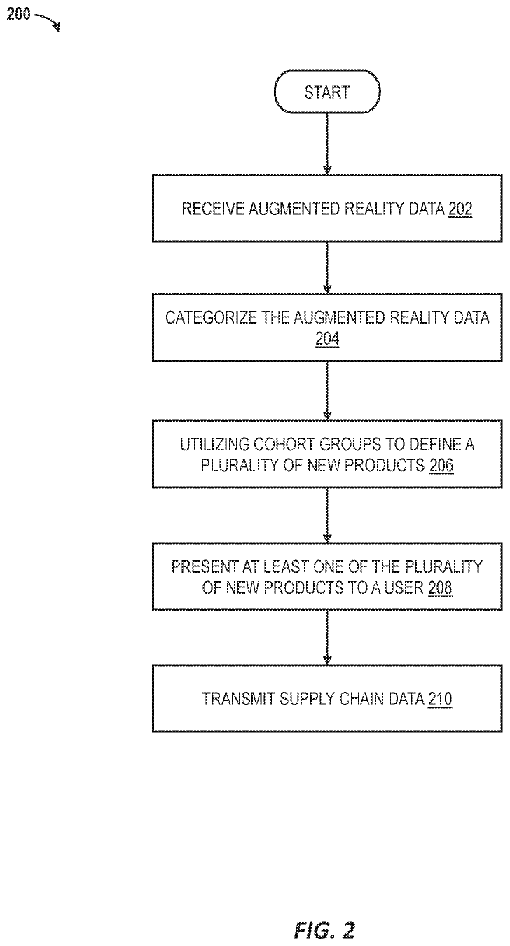

According to the present embodiment, the computer environment 100 may use the supply chain optimization module 150 to derive new and untapped data from user interactions within a metaverse environment associated with an eCommerce platform which may be utilized in providing richer training for AI based algorithms which may provide additional supply chain and/or customer preference insights. The supply chain optimization method is explained in more detail below with respect to FIG. 2.

Referring now to FIG. 2, an operational flowchart illustrating the exemplary supply chain optimization process 200 used by the supply chain optimization module 150 according to at least one embodiment is depicted.

At 202, the supply chain optimization module 150 receives augmented reality data from a plurality of users. The supply chain optimization module 150 may receive the augmented reality data (e.g., augmented user-generated data) based on user interactions with one or more products available for purchase within an associated eCommerce Platform. The plurality of users may perform the interactions with the one or more products utilizing Augmented Reality (AR) and/or Virtual Reality (VR) in a supply chain optimization user interface. As will be explained in greater detail below, the augmented reality data (e.g., augmented user-generated data) may include, but is not limited to including, interactions with one or more products, user environment images, user environment video, user environment three-dimensional (3D) scans, data collected from one or more EUDs, data provided directly by the user within the supply chain optimization user interface, swipes and/or click actions performed by the user within the supply chain optimization user interface, amongst other augmented reality data which may not be captured during traditional user product transactions.

The supply chain optimization user interface may be displayed by the supply chain optimization module 150 as an integration with a software application, such as, a dedicated software application and/or a third-party software application (e.g., eCommerce Platform, metaverse application). The user may access the user interface from one or more EUDs 103, the one or more EUDs 103 may be an AR and/or VR compatible device, including, but not limited to including, smart glasses, smart headsets, smart phones, and/or other AR and/or VR compatible devices, as well as Extended Reality (XR) and mixed reality (MR). As will be explained in more detail below, a major source of the augmented user-generated data may be from a camera associated with the one or more EUDs and/or one or more Internet of Things (IoT) devices associated with an environment. The third-party software application (e.g., eCommerce Platform, metaverse application) may utilize motion state information collected from the one or more EUDs to reflect the user's actions within the platform. The third-party software application (e.g., eCommerce Platform, metaverse application) may be a platform in which the user can experimentally interact with one or more products, some examples may include, user trying out different clothes in a metaverse store, users experimenting with new paint colors in a virtually generated environment, users interacting with furniture or decoration pieces available within the eCommerce Platform, and/or other experimental interactions with products by which the user may evaluate the products prior to purchase.

All the augmented reality data (e.g., augmented user-generated data) received and/or other data received by the supply chain optimization program based on interactions between the user and the one or more products within the third-party software application (e.g., eCommerce Platform, metaverse application), shall not be construed as to violate or encourage the violation of any local, state, federal, or international law with respect to privacy protection. The user may provide augmented reality data (e.g., augmented user-generated data) directly through the supply chain optimization user interface using the EUD 103. The augmented reality data (e.g., augmented user-generated data) which may be provided directly through the supply chain optimization interface may include images, videos, and/or 3D scans of an environment for which the user wishes to interact with the one or more products, feedback on previous orders, information that may be utilized by the user in creating a user profile, amongst other data. The information that may be utilized by the user in creating the user profile may include at least demographic data, geographical data, and/or other data relating to the attributes of the user which may be utilized in determining cohort groups from the user attributes so that the supply chain optimization module 150 may categorize anonymized augmented user-generated data. The data relating to the attributes of the user which may be provided by the user may be unique depending on the third-party software application (e.g., eCommerce Platform, metaverse application) such that the supply chain optimization module 150 may categorize the anonymized augmented user-generated data similar to the analytics used on non-metaverse generated data (e.g., non-virtual reality-based augmented user-generated data) in providing improved training data into the one or more Artificial Intelligence (AI) based algorithms which will be described in further detail below. The user may be able to monitor the augmented reality data (e.g., augmented user-generated data) being collected and/or revoke access to any of the data within the supply chain optimization user interface.

The supply chain optimization module 150 may utilize the augmented reality data (e.g., augmented user-generated data) which may be provided directly through the supply chain optimization interface such as, but not limited to, images, videos, and/or 3D scans of an environment, as well as data provided by connected or associated Internet of Things (IoT) devices with the user's profile in the third-party software application (e.g., eCommerce Platform, metaverse application) in generating an immersive digital twin of an environment, such as the user's home, which may enable the user to interact, design, build, and experiment within the immersive digital twin in conjunction with the one or more products available through the eCommerce Platform through the one or more EUDs described above. In some embodiments, the supply chain optimization module 150 may utilize the immersive digital twin generating capabilities and/or three-dimensional (3D) mapping software of the third-party software application (e.g., eCommerce Platform, metaverse application) in generating the immersive digital twin. In other embodiments, the supply chain optimization module 150 may have the capabilities of generating the immersive digital twin and rendering the environment to the user as either a dedicated software application and/or as an add-on for an existing eCommerce Platform. A digital twin may be a digital representation of at least an object, entity and/or system that spans the object, entity, and/or system's lifecycle. The digital twin may be updated using real time data, and may utilize, at least, simulation, machine learning, and/or reasoning in aiding informed decision making. Here, an immersive digital twin refers to a digital twin in which the user may directly interact with virtual representations of products offered through the eCommerce Platform within the user's environment using the AR and/or VR capable devices described above.

In an embodiment, the supply chain optimization module 150 may offer rewards and/or incentives to each of the plurality of users based on additional augmented reality data (e.g., augmented user-generated data) provided by the user within the supply chain optimization user interface. The rewards and/or incentives may be specific to a user based on additional data which may be useful in training the one or more AI based algorithms described in more detail below. For example, in addition to images, videos, 3D scans of an environment the supply chain optimization module 150 may offer rewards or incentives for connecting additional IoT devices and or providing building information for an environment, such as, but not limited to, square footage, property size, location, material used in construction, window types, year built, blueprints, roofing details, architecture, information on appliances, amongst others. As will be explained in more detail below, the supply chain optimization module 150 may offer these rewards and/or incentives in order to gather additional information with respect to cohort groups and/or geographical regions for which additional data may enable more robust training of the AI based algorithms and further identification of cohorts and potential user desired products.

The supply chain optimization module 150 may anonymize the augmented reality data (e.g., augmented user-generated data) received based on the user interactions with the one or more products of the eCommerce Platform. The supply chain optimization module 150 may anonymize the augmented reality data (e.g., augmented user-generated data) by training a Generative Adversarial Network (GAN) system with inputs from at least two of the plurality of users that adds noise to the system until the at least two users may not be discriminated between by the GAN. Then the supply chain optimization module 150 may utilize the trained neural network to reconstruct a new feature stream which may not be recognizable. Although only one single static scheme for anonymizing the augmented reality data (e.g., augmented user-generated data) may be described the supply chain optimization module 150 may additionally employee additional static and/or dynamic schemes in anonymizing the augmented reality data (e.g., augmented user-generated data). As will be explained in more detail below, the supply chain optimization module 150 may categorize the anonymized augmented reality data (e.g., anonymized augmented user-generated data) into cohort groups using attributes of the plurality of users for which the augmented user-generated data may be received.

At 204, the supply chain optimization module 150 categorizes the augmented reality data. The supply chain optimization module 150 may categorize the augmented reality data (e.g., augmented user-generated data) into one or more cohort groups according to attributes of the plurality of users for which the augmented reality data (e.g., augmented user-generated data) is received. The attributes of the plurality of users may include at least demographic data and/or geographical data collected at step 202 amongst other data which may be explained in more detail below.

The categorizing performed by the supply chain optimization module 150 may utilize the same and/or similar analytics that are utilized by the eCommerce platform and/or business associated with the eCommerce platform for non-virtual reality-based augmented user-generated data (e.g., non-Metaverse generated data). The non-Metaverse generated data may be stored in a knowledge corpus (e.g., database 130) maintained by the supply chain optimization module 150. The non-metaverse generated data may be the data traditionally utilized by the eCommerce platform in predicting supply chain needs and/or consumer preferences with respect to new products and/or new groups of products. The non-metaverse generated data may be collected from a single transaction or consumer product or from multiple consumer products or a plurality of transactions conducted by a plurality of consumers over an extended period of time, amongst other means traditionally utilized by brick and mortar businesses and/or eCommerce platforms in collecting consumer data. The non-metaverse data may also include the number of individuals that purchased a product and a corresponding breakdown of those purchases according to each of the individual's attributes. For example, the non-metaverse generated data for Product A may include the number of purchases by individuals in Region B and/or State C. Then analytics may be conducted on this non-metaverse generated data in order to predict a number of products that may be ordered from inventory in order to meet the demands of the Region B and/or State C cohort groups. As will be explained in more detail below, the supply chain optimization module 150 may additionally leverage the augmented user-generated data to predict the supply chain dynamics more accurately for Product A and understanding of cohort groups of Region B and/or State C.

The supply chain optimization module 150 may continuously receive both non-virtual reality-based augmented user-generated data (e.g., non-Metaverse generated data) and augmented reality data (e.g., augmented user-generated data) based on future user interactions of the plurality of users within the eCommerce Platform, this additional data may be utilized in continuously updating the data stored in the knowledge corpus (e.g., database 130) and enriching the training data and/or input for the one or more AI-based algorithms described below such that the supply chain optimization module 150 may continuously define and/or modify a plurality of new products and/or plurality of new groups of products based on additional cohort groups identified.

At 206, the supply chain optimization module 150 defines a plurality of new products. The supply chain optimization module 150 may define the plurality of new products and/or the plurality of new groups of products according to the categorizing of the augmented reality data (e.g., augmented user-generated data) into the one or more cohort groups.

The supply chain optimization module 150 may utilize the categorized anonymized augmented reality data (e.g., augmented user-generated data) and the non-virtual reality-based augmented user-generated data (e.g., non-Metaverse generated data) as input for the one or more AI-based algorithms for richer training and more accurate predictions of supply chain dynamics for the plurality of new products and/or the plurality of new groups of products. The plurality of new products and/or the plurality of new groups of products may enable the supply chain optimization module 150 to optimize the supply chain for future users and/or future transactions and/or may enable the supply chain optimization module 150 to improve products and/or product groups as a result of real time feedback of augmented reality data (e.g., augmented user-generated data) to improve and/or adjust the product offerings available to a current user interactively within the supply chain optimization user interface. The one or more AI-based algorithms utilized by the supply chain optimization module may include at least one-dimensional clustering algorithms and/or multi-dimensional clustering algorithms. As will be explained in more detail below, the supply chain optimization module 150 may utilize a one-dimensional clustering algorithm or a multi-dimensional clustering algorithm depending on a type of product and/or the number of features which are being defined for each of the plurality of new products.

The one-dimensional algorithms that may be utilized by the supply chain optimization module 150 may include, but are not limited to including, Jenks optimization-based clustering, Kernel Density Estimation (KDE), amongst other one-dimensional clustering algorithms. For example, the supply chain optimization module 150 may generate an immersive digital twin environment within the supply chain optimization interface based on the images, videos, and/or 3D scans of the environment provided by the user through the EUD 103. The supply chain optimization module 150 may also gather additional information from the users such as the colors or product details of the existing paint and a projected amount of paint needed for the environment which could allow a manufacturer to identify new quantities of paint and/or paint can size that may minimize waste and more appropriately serve a particular cohort group. In this example let's presume that paint cans are initially sold in k sizes which are I₁, I₂, . . . Iₖ. From usual transactions, the paint can manufacturer/supplier gets an idea of how many units of each size are sold which may be of quantity Q₁, Q₂, . . . Qₖ. On the basis of the augmented reality data (e.g., augmented user-generated data), the paint can manufacturer may receive measurements of individual paint size needs per customer for n customers c₁, . . . cₙ. Here, the supply chain optimization module 150 may utilize the one-dimensional clustering algorithms around the peaks to identify an appropriate size of paint cans to produce, wherein, based on the results of clustering, new sizes of paint cans N₁, N₂, . . . Nₘ are determined for m clusters.

The multi-dimensional algorithms that may be utilized by the supply chain optimization module 150 may include, but are not limited to including, k-means clustering, Density-based spatial clustering of applications with noise (DBSCAN), Gaussian Mixture Models, amongst other multi-dimensional clustering algorithms. For example, the augmented user-generated may include length and width of corners in a user's house, maximum determined distance from corner to window or other structure in the room, amongst other data which may be obtained by the supply chain optimization module during the interaction of the user with one or more furniture products in the virtually generated environment. In this example, the supply chain optimization module 150 may consider the two dimensions of a corner table and define the two features for the multi-dimensional clustering algorithms. The supply chain optimization module 150 may utilize the multi-dimensional clustering algorithms to identify the number of users in each cluster based on the two dimensions of the corner table and decide which sizes and/or lengths of corner tables may be optimal for the one or more cohort groups. The supply chain optimization module 150 may select a centroid of each identified cluster to be utilized for the corner table dimensions.

The examples above are illustrative of two use cases in which the supply chain optimization module 150 may leverage the augmented reality data (e.g., augmented user-generated data) in identifying additional products which may better address the consumer needs of the newly identified cohort groups. These examples are not meant to be limiting, the supply chain optimization module 150 may also redefine new products for consumer products such as, but not limited to, clothing by adjusting the sizes and/or dimensions offered based on cohort groups and/or a correct amount of insecticides that may be required for the user to address a pest infestation. In the insecticides example, the user may add images and/or stream content of the user's surroundings including the pest infestation area using the AR capabilities of the EUD 103. Here, the supply chain optimization module 150 may analyze the images and/or streamed content received from the user's EUD 103 and determine a type of insecticide and quantity that may be required for the pest infestation. The supply chain optimization module 150 may perform a real time analysis using the AI-based algorithms described above in both assisting the user in an optimal product selection and optimizing the supply chain for future users.

In an embodiment, the supply chain optimization module 150 may utilize the defined plurality of new products and/or plurality of new groups of products as well as the supply chain data associated with each of the new products to generate augmented images for each of the new products. The supply chain optimization module 150 may render the augmented images using the capabilities of at least the one or more AR/VR devices described in detail at step 202 and/or by utilizing the image rendering and/or VR capabilities of the third-party software application (e.g., eCommerce Platform, metaverse application) in generating VR images for each of the new products. The supply chain optimization module 150 may store the VR images generated for each of the new products in an image database which may be maintained by either the remote server 104, knowledge corpus (e.g., database 130), and/or the private cloud 106. This may enable the supply chain optimization module 150 to perform an offline AI-based analysis and accordingly create new products, sizes, and/or dimensions for products which may be offered to future users of the eCommerce platform based on one or more cohort groups to which that user belongs.

At 208, the supply chain optimization module 150 presents at least one or more of the plurality of new products to a user. The supply chain optimization module 150 may present the at least one of the one or more new products to the user based on at least one of the one or more cohort groups to which the user belongs. The supply chain optimization module 150 may present the one or more of the plurality of new products and/or at least one of the one or more new groups of products to the user in the supply chain optimization user interface. The one or more new products and/or one or more new groups of products presented to the user may be based on the output of the one or more AI-based algorithms for the at least one of the one or more cohort groups to which the user belongs described in detail at step 206.

The supply chain optimization module 150 may determine the at least one of the one or more cohort groups to which the user belongs based on at least the user's profile, the user's purchase and/or transaction history, geographical data provided, demographic data provided, augmented user-generated data provided by the user, and/or other data related to the attributes of the user. The supply chain optimization module 150 may utilize the attributes of the one or more cohort groups and the attributes of the user from at least the sources described above in determining the at least one cohort group to which the user belongs based on a comparison. Additionally, the supply chain optimization module 150 may determine the at least one cohort group of the user using one or more machine learning models. The one or more machine learning models may utilize at least, collaborative filtering, content-based filtering, and/or linear regression, amongst other machine learning based recommendation approaches in determining the at least one cohort group of the user. The supply chain optimization module 150 may utilize both user-based collaborative filtering and item-based collaborative filtering as well as content-based filtering and/or a hybrid of the different approaches. Item based filtering may use the similarity between products to determine whether another user would like the item or not, whereas user based may identify users with similar consumption patterns and present the one or more new items to those similar users, while the content-based approach may leverage additional information about the users and/or products in determining whether to present the one or more new items to the other users. Additionally, as was described in more detail above with respect to step 202 the supply chain optimization module 150 may offer rewards and/or incentives to each of the plurality of users in order to receive additional data which may improve the input to the one or more machine learning models. For example, the supply chain optimization module 150 may offer a future discount to a user for feedback on previously purchased products and/or free shipping to a user willing to provide additional geographic and/or demographic information. The feedback and/or additional information is then fed into the one or more machine learning models for improved cohort group identification.

The supply chain optimization module 150 present the one or more of the plurality of new products and/or at least one of the one or more new groups of products to the user based on the one or more cohort groups to which the user is determined to belong in the supply chain optimization user interface. The supply chain optimization user interface may be an immersive display in which the immersive digital twin is rendered to the user based on the augmented reality data (e.g., augmented user-generated data) received at step 202 and by which the supply chain optimization module 150 may present the one or more of the plurality of new products and/or at least one of the one or more new groups of products to the user while enabling the user to interact with the new products in the environment for which the product is intended using the EUD 103.

The supply chain optimization module 150 may display the VR images of the new products and/or a digital twin representation of the new products to the user within the supply chain optimization user interface using either a pop-up window and/or other visual overlay which the user may interact with using the EUD 103 to swipe through the new products and/or new groups of products as well as the features associated with the new products and/or new groups of products. The pop-up window and/or other visual overlay may also include additional information such as, available materials for the products, different pricing, dimensions, sizes, colors, amongst other features of the new products. The supply chain optimization module 150 may utilize the image rendering and/or VR capabilities of the third-party software application (e.g., eCommerce Platform, metaverse application) in generating VR images of the one or more new products to the user. The supply chain optimization module 150 may additionally utilize the third-party software application (e.g., eCommerce Platform, metaverse application) in enabling the user to interact with the one or more new products presented to the user within the immersive digital twin environment. In another embodiment, the supply chain optimization module 150 may utilize the specifications defined for the one or more new products at step 206 in generating a digital twin for the one or more new products, wherein the digital twin for the one or more new products may be a digital representation of the product defined according to the one or more AI-based algorithms utilized at step 206 which may be fully interactive with the immersive digital twin environment.

The supply chain optimization module 150 may utilize the swipes and/or other click actions performed by the user for the products displayed to the user in gathering additional augmented reality data (e.g., augmented user-generated data). For example, the supply chain optimization module 150 may integrate a feedback mechanism as part of the visual overlay associated with the products enabling the user to rate the features of the products to presented to the user. The feedback mechanism, may enable the user to rate the products and/or features on a scoring scale, allow for hand or other visual feedback using the EUD 103, allow for audio feedback in which the user may describe the features the user likes or dislikes about a product. The supply chain optimization module 150 may utilize the one or more sentiment analysis techniques and/or linguistic analysis techniques described in more detail below at step 210 in analyzing the feedback and storing the feedback in the knowledge corpus (e.g., database 130).

The supply chain optimization module 150 may continuously receive augmented user-generated data based on the user interactions with the one or more products in the eCommerce Platform. The supply chain optimization module 150 may utilize the additional augmented user-generated data in updating the data stored in the knowledge corpus (e.g., database 130). For example, when the supply chain optimization module 150 presents one or more of the plurality of new products to a user, the supply chain optimization module 150 may gather additional augmented reality data (e.g., augmented user-generated data) as the user interacts with the at least one new product within the immersive digital twin environment. The additional augmented reality data (e.g., augmented user-generated data) may be utilized to update the data stored in the knowledge corpus (e.g., database 130), retrain the one or more AI-based algorithms described at step 206 to more accurately define the one or more new products and/or one or more new groups of products for plurality of users, further categorize the augmented reality data (e.g., augmented user-generated data) data into more specific cohort groups and/or cohort sub-groups, and determining the one or more cohort groups to which the user belongs prior to presenting the one or more new products. For example, Geographic Region 1 may be an initial cohort group based on the non-metaverse data relied upon by Company X. However, as augmented user-generated data is gathered the supply chain optimization module 150 may begin categorizing the augmented user-generated data into cohort sub-groups within the Geographic Region 1 cohort which may enable improved defining of new products and/or groups of products for users within those cohorts. Additionally, the supply chain optimization module 150 may further leverage the feedback received from the user during the user's interaction with the one or more new products as well as other augmented reality data (e.g., augmented user-generated data) gathered during the interaction in determining whether to present the one or more new products to the other users of the same cohort and/or whether to further adjust the one or more new products and/or new groups of products prior to presenting the products to future users of the same cohort.

At 210, the supply chain optimization module 150 transmits supply chain data for the at least one of the one or more new products to a manufacturer and/or supplier. The supply chain optimization module 150 may transmit the supply chain data for the at least one of the one or more new products selected by the user within the supply chain optimization user interface. The supply chain data may include, but is not limited to including, dimensions, sizes, packaging, colors, materials, amongst other specifications of the at least one of the one or more new products. The supply chain optimization module 150 may transmit the supply chain data following the completion of the order transaction for the at least one new product by a user.

The user may complete the transaction within a pop-up window and/or other visual overlay directly within the immersive digital twin environment using an EUD 103 to perform click actions and/or swipes within the supply chain optimization user interface and/or through the eCommerce platform. In both of these embodiments, the supply chain optimization module 150 may complete the transaction in the dedicated software application and/or the third-party software application (e.g., eCommerce Platform, metaverse application) utilizing an existing transacting software integrated with the dedicated software application and/or the third-party software application. The existing transacting software may include both the payment processing infrastructure for the user to purchase the at least one new product and/or or one or more new groups of products as well as the data transmitting infrastructure for transmitting the supply chain data for the at least one new product and/or the one or more new groups of products to the manufacturer and/or supplier of the eCommerce platform.

The supply chain optimization module 150 may also receive feedback with respect to the at least one new product for which the user completed the transaction from the user. The supply chain optimization module 150 may receive the feedback through a rating and/or review of the new product provided by the user in the eCommerce platform. The user may also provide feedback on the product of the completed transaction within the supply chain optimization user interface similarly to how the user provided feedback to the products presented which is described in detail at step 208. The supply chain optimization module 150 may utilize the feedback provided to perform additional analysis to identify preferences for products based on attributes of the plurality of users and/or preferences for products of the one or more cohort groups which may enable further retraining of the AI-based algorithms, insights provided to the eCommerce Platform and/or manufacturers/suppliers, and/or improved categorizing of the augmented user-generated data into cohort groups.

The supply chain optimization module 150 may also receive feedback in the form of images, videos, and/or 3D scans of the at least one new product within the environment from either the one or more EUDs and/or one or more IoT devices associated with the environment. The visual feedback may be leveraged in further improving, at least, but not limited to, the generating of the immersive digital twin environment, generating of VR images and/or digital twins of new products to more accurately reflect the dimensions and/or specifications of the physical products offered through the eCommerce platform, the generating of the immersive digital twin environment, refining the dimensions and/or specifications of future products defined by the AI-based algorithms, amongst other improvements which may enable the present invention to continuously refine the digital representations of products and accurately produce physical products matching those digital representations for the user.

The supply chain optimization module 150 may utilize one or more sentiment analysis techniques in analyzing the feedback provided by users, the sentiment analysis of textual content may include, at least, at least, polarity classification, sentiment classification according to a pre-defined set of emotional states, subjectivity/objectivity identification, and/or feature/aspect-based sentiment analysis. The sentiment analysis of the textual content may be determined based on words, punctuation, tone, amongst other factors of text associated with the reviews and/or feedback provided by the users through the eCommerce Platform. The supply chain optimization module 150 may additionally leverage one or more linguistic analysis techniques in performing the additional analysis, the one or more linguistic analysis techniques may include, but are not limited to including, a machine learning model with Natural Language Processing (NLP), Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries), IBM Watson® Speech to Text, IBM Watson® Speech Recognition, IBM Watson® Tone Analyzer, IBM Watson® Natural Language Understanding, IBM Watson® Natural Language Classifier, amongst other implementations. For example, based on the feedback provided by the plurality of users for completed transactions the supply chain optimization module 150 may determine the local preferences of one or more geographical regions which may be utilized in further specifying categorization of the augmented user-generated data into the one or more cohort groups and retraining the one or more AI-based algorithms to further define one or more new products and/or one or more new groups of products to more specifically address the preferences of specific cohort groups. This additional analysis may provide insights which enable the eCommerce platform to centralize the production and/or manufacturing of particular products in geographic regions proximate to those cohort groups to reduce production costs, shipping costs, and other expenses. The supply chain optimization module 150 may continuously utilize the feedback received, augmented reality data (e.g., augmented user-generated data) received, and the non-Metaverse generated data in updating the knowledge corpus (e.g., database 130) which may enable the continuous retraining of the one or more AI-based algorithms to refine at least one of the plurality of new products for at least one of the cohort groups.

In an embodiment, the manufacturer and/or supplier may utilize a three-dimensional (3D) printer in supplying one or more products to the eCommerce platform. In this embodiment, the supply chain optimization module 150 may transmit 3D printing instructions to an associated 3D printer of the manufacturer and/or supplier which may be responsible for the geographic region of the user. In this embodiment, the supply chain optimization module 150 may utilize a computer-aided design (CAD) package in generating a 3D model according to the specifications of the at least one new product for which the user completed the transaction, wherein the 3D model may also include metadata with the supply chain data of the at least one of the one or more new products. The 3D printing instructions may also be generated based on the specifications of the 3D printer, which may include, but are not limited to including, 3D printer make and model, nozzle dimensions, nozzle materials, amongst other specifications. The print chamber dimensions may refer to space available for a 3D printer to print the one or more objects, wherein the width and length dimensions may be the surface area of a print bed. The print bed may be the part of the 3D printer in which the 3D printed object rests during the printing process. In this embodiment, the supply chain optimization module 150 may be able to specifically address the specific needs of users such that additional sizes and/or dimensions of products may be presented to the user.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for supply chain optimization, the method comprising:
receiving augmented reality data from a plurality of users;
categorizing the augmented reality data into one or more cohort groups according to attributes of the plurality of users;
utilizing the one or more cohort groups to define a plurality of new products; and
presenting one or more of the plurality of new products to a user based on at least one of the one or more cohort groups to which the user belongs.

2. The method of claim 1, wherein the one or more new products are presented to the user within a supply chain optimization user interface.

3. The method of claim 2, wherein the one or more new products are presented using a visual overlay within the supply chain optimization user interface, wherein the visual overlay enables the user to swipe through features associated with each of the one or more new products.

4. The method of claim 1, wherein the plurality of new products is defined using one or more Artificial Intelligence (AI) based algorithms, wherein the one or more AI based algorithms include at least a one-dimensional clustering algorithm or a multi-dimensional clustering algorithm depending on a type of product.

5. The method of claim 1, wherein determining the at least one of the one or more cohort groups to which the user belongs further comprises:
utilizing a machine learning model to compare cohort group attributes with user attributes.

6. The method of claim 1, further comprising:
transmitting supply chain data to a manufacturer for at least one of the one or more products presented to the user following a completion of an order transaction by the user.

7. The method of claim 6, further comprising:
receiving feedback from the user on the at least one product following the completion of the order transaction;
performing an analysis on the feedback received from the user, wherein the analysis includes at least that of a user sentiment; and
updating data stored in a knowledge corpus, wherein the updated data is utilized in retraining one or more AI based algorithms to refine the at least one of the plurality of new products.

8. A computer system for supply chain optimization, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
program instructions, stored on at least one of the one or more computer-readable storage media for execution by at least one of the one or more processors via at least one of the one or more memories, to receive augmented reality data from a plurality of users;
program instructions, stored on at least one of the one or more computer-readable storage media for execution by at least one of the one or more processors via at least one of the one or more memories, to categorize the augmented reality data into one or more cohort groups according to attributes of the plurality of users;
program instructions, stored on at least one of the one or more computer-readable storage media for execution by at least one of the one or more processors via at least one of the one or more memories, to utilize the one or more cohort groups to define a plurality of new products; and
program instructions, stored on at least one of the one or more computer-readable storage media for execution by at least one of the one or more processors via at least one of the one or more memories, to present one or more of the plurality of new products to a user based on at least one of the one or more cohort groups to which the user belongs.

9. The computer system of claim 8, wherein the one or more new products are presented to the user within a supply chain optimization user interface.

10. The computer system of claim 9, wherein the one or more new products are presented using a visual overlay within the supply chain optimization user interface, wherein the visual overlay enables the user to swipe through features associated with each of the one or more new products.

11. The computer system of claim 8, wherein the plurality of new products is defined using one or more Artificial Intelligence (AI) based algorithms, wherein the one or more AI based algorithms include at least a one-dimensional clustering algorithm or a multi-dimensional clustering algorithm depending on a type of product.

12. The computer system of claim 8, wherein the program instructions to determine the at least one of the one or more cohort groups to which the user belongs further comprises:
program instructions, stored on at least one of the one or more computer-readable storage media for execution by at least one of the one or more processors via at least one of the one or more memories, to utilize a machine learning model to compare cohort group attributes with user attributes.

13. The computer system of claim 8, further comprising:
program instructions, stored on at least one of the one or more computer-readable storage media for execution by at least one of the one or more processors via at least one of the one or more memories, to transmit supply chain data to a manufacturer for at least one of the one or more products presented to the user following a completion of an order transaction by the user.

14. The computer system of claim 13, further comprising:
program instructions, stored on at least one of the one or more computer-readable storage media for execution by at least one of the one or more processors via at least one of the one or more memories, to receive feedback from the user on the at least one product following the completion of the order transaction;
program instructions, stored on at least one of the one or more computer-readable storage media for execution by at least one of the one or more processors via at least one of the one or more memories, to perform an analysis on the feedback received from the user, wherein the analysis includes at least that of a user sentiment; and
program instructions, stored on at least one of the one or more computer-readable storage media for execution by at least one of the one or more processors via at least one of the one or more memories, to update data stored in a knowledge corpus, wherein the updated data is utilized in retraining one or more AI based algorithms to refine the at least one of the plurality of new products.

15. A computer program product for supply chain optimization, comprising:
one or more computer readable storage media, and program instructions collectively stored on the one or more computer readable storage media, the program instructions comprising:
program instructions, stored on at least one of the one or more computer-readable storage media, to receive augmented reality data from a plurality of users;
program instructions, stored on at least one of the one or more computer-readable storage media, to categorize the augmented reality data into one or more cohort groups according to attributes of the plurality of users;
program instructions, stored on at least one of the one or more computer-readable storage media, to utilize the one or more cohort groups to define a plurality of new products; and
program instructions, stored on at least one of the one or more computer-readable storage media, to present one or more of the plurality of new products to a user based on at least one of the one or more cohort groups to which the user belongs.

16. The computer program product of claim 15, wherein the one or more new products are presented to the user within a supply chain optimization user interface.

17. The computer program product of claim 16, wherein the one or more new products are presented using a visual overlay within the supply chain optimization user interface, wherein the visual overlay enables the user to swipe through features associated with each of the one or more new products.

18. The computer program product of claim 15, wherein the plurality of new products is defined using one or more Artificial Intelligence (AI) based algorithms, wherein the one or more AI based algorithms include at least a one-dimensional clustering algorithm or a multi-dimensional clustering algorithm depending on a type of product.

19. The computer program product of claim 15, wherein the program instructions to determine the at least one of the one or more cohort groups to which the user belongs further comprises:
program instructions, stored on at least one of the one or more computer-readable storage media, to utilize a machine learning model to compare cohort group attributes with user attributes.

20. The computer program product of claim 15, further comprising:
program instructions, stored on at least one of the one or more computer-readable storage media, to transmit supply chain data to a manufacturer for at least one of the one or more products presented to the user following a completion of an order transaction by the user.
